(19) United States
(12) Patent Application Publication
(10) Pub. No.: US 2025/0171349 A1
(43) Pub. Date: May 29, 2025

(54) MATERIAL COMPRISING A SOLAR CONTROL COATING

(71) Applicant: SAINT-GOBAIN GLASS FRANCE, COURBEVOIE (FR)

(72) Inventor: Corentin MONMEYRAN, AUBERVILLIERS (FR)

(21) Appl. No.: 18/840,592

(22) PCT Filed: Feb. 17, 2023
(86) PCT No.: PCT/FR2023/050228

§ 371 Date: Aug. 22, 2024

(30) Foreign Application Priority Data
Feb. 25, 2022 (FR) FR2201692

(51) Int. Cl. C03C 17/36

(52) U.S. Cl. CPC C03C 17/3644; C03C 17/3618; C03C 17/3626; C03C 17/366; C03C 17/3681; C03C 2217/212; C03C 2217/213; C03C 2217/256; C03C 2217/281; C03C 2217/734

(57) ABSTRACT

A material includes a substrate coated with a solar control coating, including a single silver-based metal functional layer arranged between two dielectric coatings, each dielectric coating including at least one series of three dielectric layers, referred to as a layer of higher refractive index, a layer of lower refractive index, and a layer of higher refractive index, each having a thickness of greater than 5 nm, where the variation in the refractive index between two consecutive layers is greater than 0.25. The layer of lower refractive index has the lowest refractive index and is located between the two layers of higher refractive index.

The present invention relates to the field of glazed units, and more particularly to a laminated glazed unit for the aeronautical industry, especially cockpit glazed units.

Cockpit glazed units are complex systems with multiple roles. They provide physical, acoustic and thermal protection from the outside environment.

These glazed units are therefore laminated. A laminated glazed unit comprises two or more glass substrates bonded together by polymer interlayers, also known as laminating interlayers. Aeronautical glazed units preferentially comprise two or three substrates.

Conventionally, the faces of a glazed unit are designated starting from the exterior by numbering the faces of the substrates from the outside toward the inside of the passenger compartment or of the premises which it equips. This means that the incident sunlight passes through the faces in increasing numerical order.

In the case of a laminated glazed unit, all the faces of the substrates are numbered but the faces of the laminating interlayers are not numbered. Face 1 is outside the building or the vehicle and therefore constitutes the outer wall of the glazed unit. Faces 2 and 3 are in contact with the laminated interlayer.

In the case of a laminated glazed unit comprising two substrates, face 4 is inside the building or the vehicle and therefore constitutes the inner wall of the glazed unit.

In the case of a laminated glazed unit comprising three substrates, faces 4 and 5 are in contact with the second laminating interlayer and face 6 is inside the building or vehicle and therefore constitutes the inner wall of the glazed unit.

Laminated glazed units for aerospace applications preferentially have a first substrate/first polymer interlayer/second substrate/second polymer interlayer/third substrate structure.

These laminated glazed units can further comprise coatings conferring additional functionalities. For example, at least one of the substrates can be coated with a heated de-icing coating comprising an electrically conductive layer. These electrically conductive layers can be based on oxides such as tin-doped indium oxide (ITO).

Because of their intended application, these glazed units must have high light transmission and low absorption. However, while the “substrates”, “interlayers” and “functional coatings” that make up the glazed units can let the visible part of the solar spectrum into the cockpit, they also let most infrared radiation through. As a result, the cockpit heats up excessively, and the temperature has to be compensated for by an energy-intensive air-conditioning system.

To alleviate this problem, cockpit glazed units can be fitted with a solar control (or protection) element.

The “solar control” function or property refers to a glazed unit's ability to let in visible light while blocking infrared radiation. Selectivity “s”, solar factor (SF or g) and energy transmission (Te) are used to assess this property. The selectivity corresponds to the ratio of light transmission TLᵥᵢₛ in the visible range of the glazed unit to the solar factor SF of the glazed unit (s=TLᵥᵢₛ/SF). Solar factor “SF or g” is understood to mean the ratio in % of the total energy entering the premises through the glazing to the incident solar energy. The solar factor therefore measures the contribution of a glazed unit to the heating of the “room”. The smaller the solar factor, the smaller the solar inputs. The energy transmission corresponds to the percentage of solar energy flow transmitted directly through the glazed wall.

The solar control function therefore corresponds to a sharp reduction in the energy transmission (T_{E}) and solar factor (g) of the glazed unit, combined with a slight reduction in light transmission (T_{L}).

The addition of a solar control element is designed to prevent excessive overheating. However, the addition of this element must not be at the expense of light transmission and absorption.

To this end, the applicant has developed a solar control coating that is particularly suitable for use in laminated glazed unit for a cockpit. In particular, the solar control coating offers the best compromise between low light absorption and transmission and high selectivity. In particular, the coating of the invention makes it possible to achieve selectivity values that cannot usually be obtained with a single-layer silver coating. In fact, selectivities in excess of 1.5 or even 1.6 can be achieved. Selectivity is high compared to absorption tolerance.

This coating has been designed to be integrated into a laminated glass cockpit structure. However, the coating of the invention is suitable for any application where high light transmission and high selectivity are required, in particular with a functional coating with a single layer of silver.

The invention therefore relates to a material comprising a substrate coated with a solar control coating, comprising a single silver-based metal functional layer arranged between two dielectric coatings, each dielectric coating comprising at least one series of three dielectric layers, referred to as a layer of higher refractive index, a layer of lower refractive index, and a layer of higher refractive index, each having a thickness of greater than 5 nm, where the variation in the refractive index between two consecutive layers is greater than 0.25, greater than 0.30, greater than 0.40, greater than 0.50, greater than 0.60, greater than 0.70 or greater than 0.80, the layer of lower refractive index has the lowest refractive index and is located between the two layers of higher refractive index.

The solar control coating of the invention is a single-layer silver-based coating optimized for high selectivity, particularly when used in glazed unit in contact with two media of close index (substrate and laminating interlayer). It provides high light transmission and selectivity, as well as low absorption.

The solar control coating comprises a single metal functional layer. In the following description, the term “functional” as used in “functional layer” means “capable of controlling solar radiation and/or infrared radiation”. This means that the solar control coating does not comprise other layers whose main function is to reflect infrared radiation. Specifically, the solar control coating comprises no metal layers other than the silver-based functional metal layer of significant thickness, that is, other metal layers of at least 5 nm, preferably at least 4 nm, or even at least 2 nm.

The solar control coating comprises no metal layer thicker than 5 nm other than the single functional silver-based metal layer. Preferably, the solar control coating comprises no metal layer thicker than 8 nm, or even thicker than 10 nm other than the single functional silver-based metal layer.

The applicant has discovered that it is very difficult to achieve sufficiently low absorption with silver-based solar control coatings with several functional layers. For example, the absorption on clear glass of a silver-based solar control coating with two functional layers is generally higher than 12%. This is due in particular to the presence of at least four “metal/dielectric” interfaces, each of which necessarily generates absorption.

The invention is therefore deliberately limited to coatings comprising a single silver-based functional layer, as these are likely to have visible light absorption values of less than 10% when deposited on clear glass.

In the specific application covered by the invention, solar control coatings are intended for use on one side of a substrate in contact with a laminating interlayer. These laminating interlayers have a refractive index in the visible range substantially equal to that of the mineral or organic substrates whereupon the solar control coating is deposited. The solar control coating is therefore intended for use in direct contact with two media of substantially equal refractive indices. This influences these characteristics. In particular, the solar control coating can be symmetrical with respect to the silver layer, in terms of the nature of the dielectric layers making up the dielectric coatings.

The solar control coating of the invention is optimized to be more selective than known silver-based single-layer coatings of equivalent light transmission. To achieve this, it features “higher refractive index layer//lower refractive index layer//higher refractive index layer” sequences on either side of the silver layer. The “//” symbol means that the two layers it separates are not necessarily in contact with one another. The layer of lower refractive index has the lowest refractive index and lies between the two layers of higher refractive index. The presence of these sequences of at least three dielectric layers provides better infrared filtering for the same level of light transmission. This type of layer sequence lowers the solar factor while keeping light transmission high, thus increasing selectivity.

According to the invention, the refractive index variation between two successive layers of the series of three dielectric layers is greater than 0.25, greater than 0.30, greater than 0.40, greater than 0.50, greater than 0.60, greater than 0.70 or greater than 0.80.

Improved selectivity results from precise control of optical interference effects between the different layers making up the coating. This control is achieved by selecting the type, thickness and sequence of dielectric layers making up the dielectric coatings.

The thickness limit set for each layer, of at least 5 nm, preferably at least 8 nm, or even at least 10 nm, coupled with a sufficient variation in index between 2 successive layers, are characteristics required to obtain an optical interference effect. Layers of less than 5 nm are not thick enough to have a significant interferential effect on light transmission.

Surprisingly, the best results in terms of low absorption, high light transmission and high selectivity are obtained with a solar control coating having the following feature(s):
the solar control coating further comprises one or more blocking layers located, in contact, below and/or above the metal functional layer, and/or
the dielectric coating located below the metal functional layer further comprises a layer based on zinc oxide located directly in contact with it or separated by a blocking layer, and/or
the dielectric coating located above the metal functional layer further comprises a layer based on zinc oxide located directly in contact with it or separated by a blocking layer, and/or
the layer of lower refractive index of each dielectric coating has a refractive index of less than 1.7, and/or
the layer of lower refractive index is a silicon oxide-based layer, and/or
the layer of lower refractive index has an optical thickness greater than 75 nm, greater than 90 nm, greater than 100 nm, greater than 120 nm, greater than 130 nm, greater than 150 nm,
the layer of lower refractive index has a thickness greater than 50 nm, greater than 60 nm, greater than 70 nm, greater than 80 nm, greater than 90 nm or greater than 100 nm, and/or
the layer of lower refractive index has a thickness of less than 200 nm, less than 180 nm, less than 170 nm or less than 180 nm, and/or
in a dielectric coating, the layer of lower refractive index has a geometric thickness that is at least 2 times greater, at least 3 times greater, at least 4 times greater or at least 5 times greater than each of the other two layers of higher refractive index, and/or
the layer of lower refractive index has an optical thickness that is at least 2 times greater, at least 3 times greater, least 4 times greater, than each of the other two layers of higher refractive index,
the dielectric layers of higher refractive index of each dielectric coating are chosen from silicon nitride-based, tin-zinc oxide-based, zinc oxide-based or titanium oxide-based layers, and/or
the three layers of the layer sequence are in contact with one another, that is, the first upper refractive layer is in contact with the lower refractive layer and the lower refractive layer is in contact with the second upper refractive layer, and/or
each dielectric coating comprises, starting from the metal functional layer, the same series of three dielectric layers referred to as a layer of higher refractive index, a layer of lower refractive index and a layer of higher refractive index, and/or
each dielectric coating comprises oxide layers, and the sum of the thicknesses of all the oxide layers present in each dielectric coating represents at least 50%, 60% or 70% of the total thickness of the dielectric coating in question, and/or
each dielectric coating comprises layers comprising silicon, and the sum of the thicknesses of all the layers comprising silicon present in each dielectric coating represents at least 50%, 60% or 70% of the total thickness of the dielectric coating in question, and/or
the series of at least three layers comprises:
a silicon nitride-based layer,
a silicon oxide-based layer,
a silicon nitride-based layer,
   or
a titanium oxide-based layer,
a silicon oxide-based layer,
a titanium oxide-based layer,
each dielectric coating comprises the same sequence of at least four layers, which sequence is defined from the silver-based metal functional layer, preferably the same sequence of at least four layers comprises:
a zinc-oxide-based layer,
a silicon nitride-based layer,
a silicon oxide-based layer,
a silicon nitride-based layer,
   or
a zinc-oxide-based layer,
a titanium oxide-based layer,
a silicon oxide-based layer,
a titanium oxide-based layer, and/or
the substrate is chemically tempered glass, and/or
the substrate is a curved glass.

The invention also relates to a laminated glazed unit comprising a material according to the invention and at least one second substrate, the material and the second substrate are interconnected by a first laminating interlayer. The solar control coating is preferably positioned on face 2 or 3. The first laminating interlayer is preferably made of polyurethane.

The laminated glazed unit may comprise a third substrate bonded to the second substrate or to the material via a second polymer interlayer.

The laminated glazed unit may further comprise a heating coating comprising an electrically conductive layer, located on a face of a substrate not comprising the solar control coating, preferably on face 2 or face 3.

The materials and glazed units according to the invention have a selectivity greater than 1.45 or greater than 1.5.

Preferably, all the substrates are made of curved, chemically tempered glass.

The invention also relates:
a laminated glazed unit according to the invention mounted on a vehicle or on a building, and
to the method for preparing a laminated glazed unit according to the invention,
to the use of a laminated glazed unit according to the invention as solar-control glazed unit for buildings or vehicles,
to a building or vehicle comprising a glazed unit according to the invention.

The preferred features which appear in the remainder of the description are applicable as well to the material according to the invention as, where appropriate, to the glazing, the method, the use, the building or the vehicle according to the invention.

All the describes light features are obtained according to the principles and methods of the ISO 9050 standard relating to the determination of the light and solar features of the glazed units used in glass for the construction industry.

Conventionally, the refractive indices are measured at a wavelength of 550 nm.

According to the invention, two elements such as layers or substrates have substantially equal refractive indices when the absolute value of the difference between the refractive indices of the two materials constituting said layers or substrates at 550 nm is less than or equal to 0.15.

The layers of higher refractive index and the layers of lower refractive index have different refractive indices. According to the invention, two elements such as layers or substrates have different refractive indices when the absolute value of the difference between the refractive indices of the two materials constituting said layers or substrates at 550 nm is greater than or equal to 0.25, greater than 0.30, greater than 0.40, greater than 0.50, greater than 0.60, greater than 0.70 or greater than 0.80.

Unless otherwise mentioned, the thicknesses mentioned in the present document, without other information, are real or geometrical physical thicknesses denoted Ep and are expressed in nanometers (and not optical thicknesses). The optical thickness Eo is defined as the physical thickness of the layer under consideration multiplied by its refractive index at the wavelength of 550 nm: Eo=n*Ep. As the refractive index is a dimensionless value, it may be considered that the unit of the optical thickness is that chosen for the physical thickness.

The solar control coating is deposited by magnetic-field-assisted cathode sputtering (magnetron method). According to this advantageous embodiment, all the layers of coatings are deposited by magnetic-field-assisted cathode sputtering.

Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or several) layer(s) inserted between these two layers (or layer and coating).

In the present description, unless otherwise indicated, the expression “based on”, used to characterize a material or a layer with respect to what it contains, means that the mass fraction of the constituent that it comprises is at least 50%, in particular at least 70%, preferably at least 90%.

According to the invention:
light reflection corresponds to the reflection of solar radiation in the visible part of the spectrum,
light transmission corresponds to the transmission of solar radiation in the visible part of the spectrum,
light absorption corresponds to the absorption of solar radiation in the visible part of the spectrum.

Ordinary clear glass from 4 to 6 mm thick has the following light characteristics:
light transmittance between 87 and 91.5%,
light reflection between 7 and 9.5%,
light absorption between 0.3 and 5%.

The solar control coating comprises a single silver-based metal functional layer.

The silver-based metal functional layers comprise at least 95.0%, preferably at least 96.5% and better still at least 98.0% by weight of silver, relative to the weight of the metal functional layer. Preferably, a silver-based functional metal layer comprises less than 1.0% by weight of metals other than silver, relative to the weight of the silver-based functional metal layer.

The silver-based metal functional layers have a thickness:
greater than 5 nm, 6, nm, 7 nm, 8 nm or 9 nm, and/or
less than 25 nm, 22 nm, 20 nm, 18 nm, 16 nm, 15 nm, 14 nm or 13 nm.

The solar control coating may further comprise one or more blocking layers located, in contact, below and/or above the metal functional layer.

The blocking layers conventionally have the role of protecting the functional layers from possible damage during the deposition of the upper antireflective coating and during a possible high-temperature heat treatment of the annealing, bending and/or tempering type.

The blocking layers are chosen from:
metal layers based on a metal or a metal alloy, metal nitride layers, and metal oxynitride layers of one or more elements chosen from titanium, zinc, tin, nickel, chromium and niobium,
metal oxide layers of one or more elements chosen from titanium, nickel, chromium and niobium.

The blocking layers may in particular be, as deposited, Ti, TiN, TiOx, Nb, NbN, Ni, NiN, Cr, CrN, NiCr, NiCrOx, NiCrN, SnZnN layers. When these blocking layers are deposited in the metal, nitride or oxynitride form, these layers can undergo a partial or complete oxidation according to their thickness and the nature of the layers which surround them, for example, during the deposition of the following layer or by oxidation in contact with the underlying layer.

Preferably, the blocking layers are titanium layers, that is, these layers have been deposited as titanium metal.

According to advantageous embodiments of the invention, the blocking layer or layers satisfy one or several of the following conditions:
the metal functional layer is in contact with a blocking overlayer, and/or
the blocking layers are titanium layers deposited in metal form, and/or
the thickness of each blocking layer is at least 0.05 nm, or between 0.08 and 2.00 nm or between 0.10 and 1.00 nm, or between 0.05 and 0.50 nm.

The sum of the thicknesses of all the blocking layers can be less than 2.0 nm, less than 1.5 nm, less than 1.0 nm or less than 0.5 nm.

The dielectric coatings comprise dielectric layers. “Dielectric layer” within the meaning of the present invention should be understood as meaning that, from the perspective of its nature, the material is “nonmetallic”, that is, is not a metal. In the context of the invention, this term denotes a material exhibiting an n/k ratio over the entire wavelength range of the visible region (from 380 nm to 780 nm) which is equal to or greater than 5.

Preferably, each dielectric coating consists solely of one or more dielectric layers. Preferably, there is thus no absorbing layer in the dielectric coatings, in order not to reduce the light transmission.

The dielectric layers of the coatings exhibit the following characteristics, alone or in combination:
they are deposited by magnetic-field-assisted cathode sputtering,
they have a thickness of greater than 2 nm, preferably between 4 and 200 nm.

The dielectric layers, in addition to their optical function, may have different other functions. By way of example, mention may be made of stabilizing layers, smoothing layers, and barrier layers.

The dielectric layers are conventionally selected from oxide-based, nitride-based or oxynitride-based layers. The layers based on oxide of one or more elements comprise essentially oxygen and very little nitrogen. The layers based on oxide in particular comprise at least 90%, as atomic percentage, of oxygen relative to the oxygen and nitrogen in said layer. The layers based on nitride comprise essentially nitrogen and very little oxygen. The layers based on nitride comprise at least 90%, as atomic percentage, of nitrogen relative to the oxygen and nitrogen in said. The layers based on oxynitride comprise a mixture of oxygen and nitrogen. The layers based on silicon oxynitride comprise 10 to 90% (limit values excluded), as atomic percentage, of nitrogen relative to the oxygen and nitrogen in said layer.

The amounts of oxygen and nitrogen in a layer are determined by atomic percentages relative to the total amounts of oxygen and nitrogen in the layer in question.

Dielectric layers are conventionally selected from:
layers comprising silicon, aluminum and/or zirconium, optionally doped with at least one other element,
layers based on zinc tin oxide,
titanium oxide-based layers,
zinc oxide-based layers.

The layers comprising silicon comprise at least 50% by weight of silicon relative to the weight of all the elements forming the layer comprising silicon, other than nitrogen and oxygen.

The layers comprising silicon may be selected from layers based on oxide, based on nitride or based on oxynitride, such as layers based on silicon oxide, layers based on silicon nitride and layers based on silicon oxynitride.

The layers based on silicon oxide comprise at least 90%, as atomic percentage, of oxygen relative to the oxygen and nitrogen in the layer based on silicon oxide. The layers based on silicon nitride comprise at least 90%, as atomic percentage, of nitrogen relative to the oxygen and nitrogen in the layer based on silicon nitride. The layers based on silicon oxynitride comprise 10 to 90% (limit values excluded), as atomic percentage, of nitrogen relative to the oxygen and nitrogen in the layer based on silicon oxide. The layers based on silicon oxide are preferably characterized by a refractive index at 550 nm of less than or equal to 1.55. The layers based on silicon nitride are preferably characterized by a refractive index at 550 nm of greater than or equal to 1.95.

The layers comprising silicon may comprise, or consist of, elements other than silicon, oxygen and nitrogen. These elements may be selected from aluminum, boron, titanium and zirconium. The layers comprising silicon may comprise at least 2%, at least 5%, or at least 8% by weight of aluminum relative to the weight of all the elements forming the layer comprising silicon oxide, other than oxygen and nitrogen.

The layers comprising aluminum may be selected from layers based on oxide, based on nitride or based on oxynitride, such as layers based on aluminum oxide, such as Al₂O₃, layers based on aluminum nitride, such as AlN, and layers based on aluminum oxynitride, AlOxNy.

Among the dielectric layers, a distinction is made, according to their refractive index at 550 nm, between low-refractive-index layers, medium-refractive-index layers and high-refractive-index layers. The low-refractive-index layers have a refractive index of less than 1.70. The medium-refractive-index layers have a refractive index of between 1.70 and 2.2. The high-refractive-index layers have a refractive index greater than 2.2.

The low-index layers may have a refractive index of less than 1.70, less than 1.6 or less than 1.5. The low-refractive-index layers are preferably silicon-oxide-based layers.

The layers of intermediate refractive index can be selected from:
the layers based on zinc oxide (n550=2.0),
the layers based on tin oxide (n550=2.0),
layers based on zinc tin oxide (n550=2.0),
the silicon- and/or aluminum-nitride-based layers (n550 nm=2.0),
the silicon- and/or aluminum-oxynitride-based layers.

The high-refractive-index layers may have a refractive index:
greater than 2.30, greater than 2.35, or greater than 2.40.
less than 2.60, less than 2.50, less than 2.40.

The high-refractive-index layers can be chosen from:
the layers based on titanium oxide (n550=2.4),
the layers based on mixed oxide of titanium and another component selected from the group consisting of Zn, Zr and Sn,
the layers based on a zirconium nitride layer (n 550=2.55),
the zirconium-silicon-nitride-based layers (n550 nm=2.20-2.40),
the layers based on a layer of zirconium oxide,
the layers based on manganese oxide MnO (n550=2.16),
the layers based on a layer of tungsten oxide (n550=2.15),
the layers based on a layer of niobium oxide (n550=2.30),
the layers based on a layer of bismuth oxide (n 550=2.60),

The layer of lower refractive index can be selected from the low refractive index layers. In this case, the layers of higher refractive index are chosen from the layers with a refractive index greater than 1.7. They are therefore chosen from intermediate refraction layers and the layers of high refractive index.

The layer of lower refractive index can be selected from the intermediate refractive index layers. In this case, the layers of higher refractive index are chosen from the layers with a high refractive index.

The dielectric coatings can comprise so-called stabilizing layers that reinforce the adhesion of the metal functional layer to the surrounding layers, and thereby oppose migration of its constituent material. The stabilizing layers are preferably layers based on zinc oxide optionally doped, for example, with aluminum. The zinc oxide is crystallized. The layer based on zinc oxide comprises, in increasing order of preference, at least 90.0%, at least 92%, at least 95%, at least 98.0% by mass of zinc relative to the mass of elements other than oxygen in the zinc oxide-based layer.

According to this embodiment, the dielectric coating located below the metal functional layer may further comprise a layer based on zinc oxide located directly in contact with it or separated by a blocking layer. This is because it is advantageous to have a stabilizing layer below a metal functional layer, as it facilitates the adhesion and the crystallization of the silver-based metal functional layer and enhances its quality and its stability.

According to this embodiment, the dielectric coating located above the metal functional layer further comprises a layer based on zinc oxide located directly in contact with it or separated by a blocking layer. It is also advantageous to have a stabilizing layer, above a metal functional layer, in order to increase the adhesion thereof and to optimally oppose the diffusion on the side of the stack opposite the substrate.

In these embodiments, the zinc oxide-based layers are distinct from the three dielectric layers referred to as a layer of higher refractive index, a layer of lower refractive index and a layer of higher refractive index.

The zinc oxide layers have, in increasing order preferably, a thickness of:
at least 3.0 nm, at least 4.0 nm, at least 5.0 nm, and/or
at most 15 nm, at most 10 nm, at most 8.0 nm.

The sum of the physical thicknesses of all the layers comprising silicon in each dielectric coating is greater than 50%, 60% or 70% of the total thickness of the dielectric coating considered.

The sum of the physical thicknesses of all the oxide layers of each dielectric coating is greater than 50%, 60% or 70% of the total thickness of the dielectric coating considered.

The solar control coating is preferably symmetrical with respect to the agent layer. This means that identical layer sequences are found on either side of the silver layer. The following features alone or in combination define this symmetry:
the dielectric layers of higher refractive index of the same dielectric coating may be of the same type, and/or
the dielectric layers of lower refractive index of each dielectric coating may be of the same type, and/or
the dielectric layers of higher refractive index closest to the metal functional layer of each dielectric coating may be of the same type, and/or
the dielectric layers of higher refractive index furthest from the metal functional layer of each dielectric coating may be of the same type, and/or
the ratio of the optical or geometric thicknesses of the dielectric coatings is between 0.8 and 1.2, or 0.9 and 1.1, and/or
each dielectric coating comprises, starting from the metal functional layer, the same series of three dielectric layers referred to as a layer of higher refractive index, a layer of lower refractive index and a layer of higher refractive index, and/or
the series of three layers comprises:
a silicon nitride-based layer,
a silicon oxide-based layer,
a silicon nitride-based layer,
   or
a titanium oxide-based layer,
a silicon oxide-based layer,
a titanium oxide-based layer,
each dielectric coating comprises the same sequence of at least four layers, which sequence is defined from the silver-based metal functional layer, and/or
the same sequence of at least four layers comprises:
a zinc-oxide-based layer,
a silicon nitride-based layer,
a silicon oxide-based layer,
a silicon nitride-based layer,
   or
a zinc-oxide-based layer,
a titanium oxide-based layer,
a silicon oxide-based layer,
a titanium oxide-based layer.

Examples of a three-layer series according to the invention comprise:
titanium oxide-based layer//silicon oxide-based layer//titanium oxide TiO₂ based layer,
silicon nitride-based layer//silicon oxide-based layer//silicon nitride-based layer,
silicon nitride-based layer//silicon oxide-based layer//titanium oxide TiO₂ based layer,
titanium oxide-based layers//silicon oxide-based layer//silicon nitride-based layer,
silicon and zirconium nitride-based layer//silicon oxide-based layer//silicon and zirconium nitride-based layer,
silicon and zirconium nitride-based layer//silicon nitride-based layer//silicon and zirconium nitride-based layer.

The invention also relates to a laminated glazed unit, preferably comprising at least three substrates. This particular structure, based on at least three substrates bonded together by two polymer interlayers, is particularly suited to aeronautical applications.

According to an advantageous embodiment, the glazed unit comprises:
a first chemically tempered substrate, optionally curved,
a first laminating interlayer,
a second chemically tempered substrate, optionally curved,
a second laminating interlayer,
a third chemically tempered substrate, optionally curved.

The laminated glazed unit may further comprise a heating coating comprising an electrically conductive layer, located on a face of a substrate not comprising the solar control coating, preferably on face 2 or face 3.

The laminated glazed unit of the invention may therefore further comprise:
a heating coating,
a solar control coating comprising at least one silver-based layer,
   the heating coating and the solar control coating are each preferably in contact with the first laminating interlayer, on one face of the first substrate and on one face of the second substrate.

Suitable heating coatings according to the invention are disclosed in particular in application WO 2020/120879. The heating coating comprises at least one electrically conductive layer which is a transparent conductive oxide layer.

Heating is by Joule effect. The heating coating is powered by energized electrodes. Homogeneous heating of a non-rectangular shape is impossible with a layer of homogeneous electrical conductivity.

To homogenize heating on a complex surface such as a windshield, the electrically conductive layer can have an electrical conductivity gradient. This gradient can be obtained by a thickness gradient. Large variations in layer thickness can be used to limit current density in certain parts of the heating surface.

To homogenize the heating, the electrically conductive layer can also comprise ablation lines, called flow separation lines or more commonly flow lines as disclosed in patent EP1897412-B1, which guide the flow of electric current.

These two strategies can be used in combination.

The electrically conductive layer has one or more of the following features:
it is located on an inward-facing face of the first substrate or on an inward-facing or outward-facing face of the second substrate, and/or
it comprises a conductive oxide layer based on a doped metal oxide such as tin-doped indium oxide (ITO, “Indium Tin Oxide”), aluminum-doped zinc oxide (AZO, “Aluminum Zinc Oxide”), fluorine-doped tin oxide (SnO2:F), and/or
it has a thickness of 2 to 1600 nm, preferably 30 to 300 nm or 50 to 250 nm, and/or
it has a thickness greater than 50 nm, greater than 100 nm, greater than 150 nm, which means it has this thickness over at least part of the substrate surface, and/or
it has a thickness gradient, that is, a variation in its thickness, which is expressed for example by the existence of at least two zones of different thickness and a ratio between the thickness of these two zones greater than 2, 3, 4 or 6, and/or
it has flow lines to guide the electric current, preferably with a width of between 5 and 1000 μm.

The thickness ratio between these two zones of different thicknesses is therefore the ratio of the thickness of the thicker layer to the thickness of the thinner layer.

When the substrate is chemically tempered glass, the functional coating and the heating coating are necessarily deposited after the chemical tempering step. These coatings do not undergo any post-deposition heat treatment step other than the lamination step. It is therefore preferential for them to have acquired their definitive properties directly after deposition.

The substrates can be made of mineral glass or transparent polymer material.

The mineral glass substrates that make up the glazed unit can be soda-lime, aluminosilicate or borosilicate glass.

Preferably, the mineral glass substrate is:
a chemically tempered glass, and/or
a curved glass.

Chemically tempered glass substrates comprise a compressed surface zone obtained by ion exchange. This compressed surface zone is obtained by the surface substitution of a glass substrate ion (usually an alkali ion such as sodium or lithium) by an ion with a larger ionic radius (usually an alkali ion, such as potassium or sodium). This creates compressive stresses on the surface of the glass substrate, down to a certain depth. These compressive surface stresses are balanced by the presence of a central tension zone. There is therefore a certain depth at which the transition between compression and tension occurs, a depth called the surface exchange depth.

These chemically tempered glass substrates can be defined as follows:
they comprise a compressed surface zone obtained by ion exchange, and/or
they have a surface exchange depth greater than 50 μm, and/or
they have compressive surface stresses in excess of 100 MPa.

Chemical tempering methods are well known. Reference may in particular be made to patent application WO1994008910.

Substrates can be made of transparent polymeric material, including poly(methyl methacrylate) (PMMA), polycarbonate (PC), polyurethane or polyurea (PU) substrates

The solar control and heating coatings must be applied after the chemical reinforcement step. These coatings do not normally undergo a post-deposition heat treatment step. It is therefore preferential for them to have acquired their definitive properties directly after deposition.

Preferably, the laminating interlayers comprise one or more sheets of organic polymers. Organic polymers are selected from polyvinyl butyral (PVB), polyurethanes (PU), polyureas, ethylene vinyl acetate (EVA), polyolefins (including polyethylene (PE), polypropylene (PP) or polyisobutylene (P-IB)), polyvinyl chloride and its derivatives (e.g. polyvinyl dichloride (PVDC)), styrenic polymers (e.g. polystyrene (PS), acrylostyrene butadiene (ABS), styrene acrylonitrile (SAN)), polyacrylics (including polyacrylonitrile (PAN) and poly(methyl methacrylate) (PMMA)), polyesters (including poly(ethylene terephthalate) (PET) and poly(butylene terephthalate) (PBT)), polyoxymethylene (POM), polyamides (PA), fluoropolymers such as polychlorotrifluoroethylene (PCTFE), polycarbonates (PC), aromatic polysulfones including polysulfone (PSU), polyphenylene ethers (PPE), epoxies (EP) alone or in blends and/or copolymers of several of these.

The particular structure, based on at least three substrates bonded together by two polymer interlayers, is particularly suited to aeronautical applications. In the case of an aircraft, the first substrate is not held by a vehicle connection system. Only the other two substrates, known as structural substrates, are held.

The first substrate constitutes the outer part of the glazed unit. It is not structurally attached to the vehicle or building which it equips. It is simply held to the second substrate by the polymer interlayer.

The second and third substrates are mechanically attached in the building or vehicle. These two substrates ensure the protection of people inside the vehicle. The assembly formed by the second substrate, the second polymer interlayer and the third substrate must therefore offer excellent impact resistance.

As a result, the edge of the first substrate can be set back from that of the second substrate to prevent delamination due to deformation of the glazed unit under aircraft pressure, or to peripheral tearing and/or shearing of the outer substrate.

The first polymer interlayer is preferably polyurethane-based. The specific choice of this material for this polymer interlayer is justified by the fact that it is less hygroscopic, that is, less likely to absorb and/or retain water, than other polymer interlayers for example made from PVB. This first interlayer keeps the substrate furthest out, and therefore most susceptible to extreme weather conditions.

The second polymer interlayer is preferably based on polyvinylbutadiene. The specific choice of this material for the polymer interlayer is justified by its better mechanical properties, particularly in terms of impact resistance. In addition, because of its “inner” position, its chemical durability is less critical than that of the first polymer interlayer.

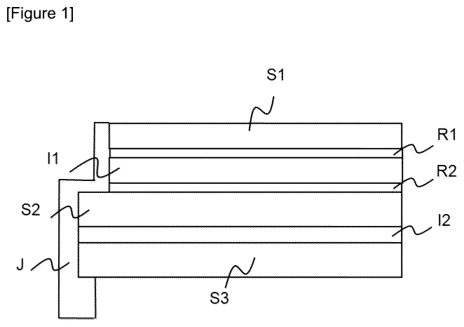

FIG. 1 schematically shows a cross-sectional view of one embodiment of a laminated glazed unit according to the invention for a cockpit. A laminated glazed unit according to the invention thus comprises:
a first glass substrate S1 constituting an outer face of the curved, chemically tempered glazed unit, for example 3 mm thick,
a first polyurethane (PU) interlayer 11, for example 5 mm thick,
a second curved, chemically tempered glass substrate S2, for example 6 mm thick,
a second 1.1 mm thick polyvinyl butyral (PVB) interlayer 12,
a third curved, chemically tempered glass substrate S3, for example 6 mm thick,
possibly two coatings R1 and R2, including a heating coating and a solar control coating.

Preferably, the entire peripheral edge of the laminated glazed unit is covered by a gasket (J). This includes the side edge of the first glass substrate, the side edge of the first interlayer, a portion of the surface of the second glass substrate projecting beyond the first glass substrate, the side edge of the second glass substrate, the side edge of the second interlayer and the side edge of the third glass substrate.

Another object of the invention consists in the use of a laminated glazed unit disclosed above as building, ground, air or water vehicle glazed unit, in particular as aircraft cockpit glazed unit.

Lastly, the invention relates to the method for preparing a laminated glazed unit, comprising the following steps:
a bending step of two or three chemically tempered substrates, then
a step of depositing, by sputtering, a solar control coating on one of the faces of a substrate to obtain a material according to the invention and optionally, a step of depositing a heating coating on one of the faces of a substrate not comprising the solar control coating,
a lamination step by heating the two or three substrates.

### EXAMPLES

### I. Materials and Coatings

### 1. General

In these examples, the glass substrates are chemically tempered, curved aluminosilicate glass substrates.

The laminated interlayers are selected from:
6.5 mm polyurethane, or
0.38 mm PVB,
1.1 mm PVB.

The functional coatings are described below.

### 2. Solar Control Coating

The functional metal layers (FL) are silver (Ag) layers. The blocking layers are titanium (Ti) metal layers. The dielectric coatings comprise layers selected from:
layers based on titanium oxide (TiOx, n=2.4),
layers based on zinc tin oxide (SnZnO, n=2.0),
layers based on silicon nitride (Si3N4, n=2.0),
layers based on silicon oxide (SiO2, n=1.5),
layers based on zinc oxide (ZnO, n=2.0).

The conditions for deposition of the layers, which were deposited by sputtering (“magnetron cathode” sputtering), are summarized in table 1.

TABLE 1
Tab. 1

| | | Deposition | | |
|---|---|---|---|---|
| Layer | Target used | pressure | | Gas |
| ZnO | Zn:Al | 1.8*10⁻³ | mbar | Ar/(Ar + O2) |
| | (98:2% by wt) | | | at 63% |
| SnZnO | Zn:Sn at | 2.10⁻³ | mbar | Ar/(Ar + O2) |
| | 64:36% at | | | at 50% |
| TiO₂ | TiOx | 2.10⁻³ | mbar | Ar/(Ar + O2) |
| | | | | at 95% |
| Ti | Ti | 2-3*10⁻³ | mbar | Ar at 100% |
| Ag | Ag | 8.10⁻³ | mbar | Ar at 100% |
| SiO₂ | Si:Al | 2.10⁻³ | mbar | Ar/(Ar + O2) |
| | (92:8% by wt) | | | at 62.5% |
| Si₃N₄ | Si:Al | 3.2*10⁻³ | mbar | Ar/(Ar + N2) |
| | (92:8% by wt) | | | at 55% |

Wt: Weight;
at: Atomic

Solar control coatings as defined below are deposited on glass substrates.

Table 2 lists the materials and the physical thicknesses in nanometers (unless otherwise indicated) for each layer or coating that forms the coatings as a function of their position with respect to the substrate bearing the stack (final line at the bottom of the table).

TABLE 2

| Table 2 | Cp.1 | Cp.2 | Cp.4 | CS.A | CS.B | CS.C | CS.D | CS.E |
|---|---|---|---|---|---|---|---|---|
| Si₃N₄ | — | 10 | — | | — | — | — | — |
| TiO₂ | — | 140 | — | — | — | 19 | — | — |
| Si₃N₄ | — | 10 | — | 28 | 30 | — | 25 | 22 |
| SiO₂ | — | — | — | 153 | 156 | 151 | 158 | 149 |
| Si₃N₄ | 38 | — | 25 | 10 | 12 | — | 10 | 14 |
| TiO₂ | — | — | — | — | — | 14 | — | — |
| ZnO | 5 | 5 | 5 | 5 | 5 | 5 | 5 | 5 |
| BL: Ti | 0.1 | 0.1 | 0.1 | 0.1 | 0.1 | 0.1 | 0.1 | 0.1 |
| FL: Ag | 14 | 10 | 10 | 12 | 12 | 16 | 12 | 12 |
| ZnO | 5 | 5 | 5 | 5 | 5 | 5 | 5 | 5 |
| Si₃N₄ | — | 10 | — | 19 | 20 | 18 | 16 | 14 |
| TiO₂ | 22 | 14 | — | — | — | — | — | — |
| SiO2 | — | — | — | 103 | 131 | 120 | 141 | 149 |
| Si₃N₄ | 13 | 10 | 24 | 91 | 16 | — | 19 | 22 |
| TiO₂ | — | — | — | — | — | 11 | — | — |

| | |
|---|---|
| Substrate (mm) | 2 or 6 |

BL: Blocking layer; FL: Metal functional layer.

Finally, two comparative solar control coatings comprising more than one layer of silver were also used:
Cp.5: Substrate/Si₃N₄ 31 nm/ZnO 5 nm/Ag 8 nm/Ti 0.1 nm/ZnO 5 nm/Si₃N₄70 nm/ZnO 5 nm/Ag 8 nm/Ti 0.1 nm/ZnO 5 nm/Si₃N₄ 39 nm.
Cp.6: Substrate/Si₃N₄ 33 nm/ZnO 5 nm/Ag1 8 nm/Ti 0.1 nm/ZnO 5 nm/Si₃N₄ 73 nm/ZnO 5 nm/Ag 8 nm/Ti 0.1 nm/ZnO 5 nm/Si₃N₄ 81 nm/ZnO 5 nm/Ag 8 nm/Ti 0.1 nm/ZnO 5 nm/Si₃N₄ 42 nm.

### 2. Heating Coating

The heating coating consists of a 200 nm indium tin oxide layer. This layer was deposited by magnetron sputtering on a 3 mm glass substrate. It has a layer resistance of 10Ω/□ measured by induction.

This substrate is used in some examples as a glass substrate coated with a heating coating comprising an ITO-based electrically conductive layer.

### II. Configurations

### 1. Glazings

The laminated glazed units have the following configuration: a first glass substrate 2 mm thick, optionally coated on face 2 with a solar control coating/a first PVB interlayer (0.38 mm)/a second glass substrate 2 mm thick.

TABLE 3
Tab. 3

| Glazing | Face 2 |
|---|---|
| Ref. | No coating |
| V.11 | Coating Cp. 1 |
| V.21 | Coating Cp. 2 |
| V.41 | Coating Cp. 4 |
| V.51 | Coating Cp. 5 |
| V.61 | Coating Cp. 6 |
| V.A1 | CS. A coating |
| V.B1 | CS. B coating |
| V.C1 | CS. C coating |
| V.F1 | CS. D coating |
| V.G1 | CS. E coating |

TABLE 4

| Tab. 4 | Ref. | V.11 | V.21 | V.41 | V.51 | V.61 |
|---|---|---|---|---|---|---|
| Abs (%) | 1.6 | 7.6 | 5.7 | 7.5 | 12.4 | 17.7 |
| T_{L} (%) | 90.3 | 80.9 | 81.1 | 82.0 | 80.0 | 74.8 |
| T_{E} (%) | 82.2 | 54.2 | 55.5 | 58.3 | 51.6 | 44.9 |
| g (%) | 84.8 | 58.1 | 59.2 | 62.2 | 57.0 | 51.6 |
| s | 1.06 | 1.39 | 1.37 | 1.32 | 1.40 | 1.45 |

TABLE 5

| Tab. 5 | Inv. A1 | Inv. B1 | Inv. C1 | Inv. F1 | Inv. G1 |
|---|---|---|---|---|---|
| Abs (%) | 10.5 | 8.8 | 7.3 | 8.8 | 9.0 |
| T_{L} (%) | 80.6 | 82.4 | 81.7 | 82.5 | 82.6 |
| T_{E} (%) | 46.8 | 50.1 | 45.2 | 50.6 | 50.9 |
| g (%) | 51.3 | 54.3 | 48.9 | 54.8 | 55.0 |
| s | 1.57 | 1.52 | 1.67 | 1.51 | 1.50 |

This solution considerably improves light transmission and selectivity. In this range of stacks with a very high T_{L} after lamination, comparative examples that do not comprise a series of three layers, referred to as a layer of higher refractive index, a layer of lower refractive index and a layer of higher refractive index, have a much lower selectivity than the glazed units according to the invention, irrespective of the number of silver layers.

### 2. Optimized Glazed Unit for Aeronautics

The laminated glazed units have the following configuration: a first glass substrate 3 mm thick, coated on face 2 with a heating coating/a first polyurethane (PU) interlayer/a second glass substrate 6 mm thick, optionally coated on face 3 with a solar control coating/a second polyvinyl butyral (PVB) interlayer/a third substrate 6 mm thick.

The reference glazed unit does not comprise a solar control coating.

The comparative glazed unit and the glazed unit according to the invention comprise a solar control coating on face 3 of the glazed unit corresponding to the first face of the second substrate.

Glazed units Cp.1 to Cp.4 comprise a non-optimized solar control coating according to the invention.

The glazed units according to the invention comprise a solar control coating according to the invention.

TABLE 6
Table 6

| Glazing | Face 2 | Face 3 |
|---|---|---|
| Ref. | ITO | — |
| V.12 | ITO | Coating Cp. 1 |
| V.22 | ITO | Coating Cp. 2 |
| V.42 | ITO | Coating Cp. 4 |
| V.52 | ITO | Coating Cp. 5 |
| V.62 | ITO | Coating Cp. 6 |
| V.A2 | ITO | CS. A coating |
| V.B2 | ITO | CS. B coating |
| V.C2 | ITO | CS. C coating |
| V.F2 | ITO | CS. D coating |
| VG2 | ITO | CS. E coating |

The optical properties and energy performance were determined by simulation on the laminated glazed units.

TABLE 7

| Tab. 7 | Ref. | V.12 | V.22 | V42 | V.52 | V.62 |
|---|---|---|---|---|---|---|
| Abs (%) | 10.7 | 15.4 | 14.5 | 17.1 | 20.1 | 24.7 |
| T_{L} (%) | 78.9 | 71.3 | 70.9 | 72.0 | 69.9 | 65.4 |
| T_{E} (%) | 53.8 | 40.1 | 39.1 | 42.1 | 38.9 | 34.8 |
| g (%) | 63.2 | 50.3 | 49.0 | 52.3 | 50.4 | 47.4 |
| s | 1.25 | 1.42 | 1.45 | 1.38 | 1.39 | 1.38 |

TABLE 8

| Tab. 8 | Inv. A2 | Inv. B2 | Inv. C2 | Inv. D2 | Inv. E2 |
|---|---|---|---|---|---|
| Abs (%) | 18.3 | 17.2 | 16.1 | 17.0 | 16.8 |
| T_{L} (%) | 70.2 | 71.9 | 71.2 | 72.0 | 72.0 |
| T_{E} (%) | 34.9 | 37.2 | 34.4 | 37.4 | 37.6 |
| g (%) | 45.2 | 47.3 | 44.1 | 47.6 | 47.8 |
| s | 1.55 | 1.52 | 1.62 | 1.51 | 1.51 |

V.52 and V.62 glazed units with functional coatings of 2 and 3 layers of silver do not achieve sufficiently high light transmission. In particular, they have a light absorption of over 20%.

The glazed units according to the invention and comparative glazed units V.12 to V.14 all comprise a functional coating with a single layer of silver. They all have substantially equal light transmission values (between 70 and 72%).

V.12 to V.42 glazed units do not offer high light transmission and selectivity. The V.22 glazed unit comprises sequences of three low-index/high-index/low-index layers.

The glazed units according to the invention have a high light transmission/selectivity ratio owing to their excellent infrared filtering effect.

Without reducing light transmission, the invention makes it possible to improve selectivity by more than 20% compared with a glazed unit without a solar control coating (comparison of glazed units with the invention and Ref). The significant improvement in selectivity is also achieved compared to a glazed unit with a non-optimized solar control coating according to the invention (comparison of the glazed units of the invention and V.12).

The invention enables a reduction in solar factor of more than 5 percentage points compared with a glazed unit with a non-optimized solar control coating according to the invention.

The glazed units according to the invention offer the best compromise between high light transmission and selectivity and low solar factor.

1. A material comprising a substrate coated with a solar control coating,
comprising a single metal functional layer arranged between two dielectric coatings, the metal functional layer is silver-based, wherein each dielectric coating comprises at least one series of three dielectric layers, which includes a first layer of higher refractive index, a second layer of lower refractive index, and a third layer of higher refractive index, each having a thickness of greater than 5 nm, wherein a variation in the refractive index between two consecutive layers of the at least one series of three dielectric layers is greater than 0.25, the second layer of lower refractive index has the lowest refractive index and is located between the first and third layers of higher refractive index.

2. The material according to claim 1, wherein the solar control coating further comprises one or more blocking layers located, in contact, below and/or above the metal functional layer.

3. The material according to claim 1, wherein the dielectric coating located below the further comprises a layer based on zinc oxide located directly in contact with the metal functional layer or separated by a blocking layer.

4. The material according to claim 1, wherein the dielectric coating located above the metal functional layer further comprises a layer based on zinc oxide located directly in contact with the metal functional layer or separated by a blocking layer.

5. The material according to claim 1, wherein the second layer of lower refractive index of each dielectric coating has a refractive index of less than 1.7.

6. The material according to claim 5, wherein the second layer of lower refractive index is a silicon oxide-based layer.

7. The material according to claim 1, wherein the second layer of lower refractive index has an optical thickness of less than 75 nm.

8. The material according to claim 1, wherein, in a dielectric coating, the second layer of lower refractive index has a geometric thickness which is at least 2 times greater than each of the other first and third layers of higher refractive index.

9. The material according to claim 1, wherein the first and third dielectric layers of higher refractive index of each dielectric coating are chosen from silicon nitride-based, tin-zinc oxide-based, zinc oxide-based or titanium oxide-based layers.

10. The material according to claim 1, wherein each dielectric coating comprises, starting from the metal functional layer, a same series of the three dielectric layers.

11. The material according to claim 10, wherein the series of three layers comprises:
a silicon nitride-based layer,
a silicon oxide-based layer,
a silicon nitride-based layer,
or
a titanium oxide-based layer,
a silicon oxide-based layer,
a titanium oxide-based layer.

12. The material according to claim 1, wherein each dielectric coating comprises a same sequence of at least four layers, which sequence is defined from the silver-based metal functional layer.

13. The material according to claim 12, wherein the same sequence of at least four layers comprises:
a zinc-oxide-based layer,
a silicon nitride-based layer,
a silicon oxide-based layer,
a silicon nitride-based layer,
or
a zinc-oxide-based layer,
a titanium oxide-based layer,
a silicon oxide-based layer,
a titanium oxide-based layer.

14. The material according to claim 1, wherein the substrate is a chemically tempered glass.

15. The material according to claim 1, wherein the substrate is a curved glass.

16. A laminated glazed unit comprising a material according to claim 1 and at least one second substrate, the material and the second substrate are bonded together via a first laminating interlayer, face 1 of the laminated glazed unit is on an outside of the building or vehicle and constitutes an outer wall of the laminated glazed unit, faces 2 and 3 of the laminated glazed unit are in contact with the first laminating interlayer.

17. The laminated glazed unit according to claim 16, wherein the solar control coating is positioned on face 2 or 3.

18. The laminated glazed unit according to claim 16, further comprising a heating coating comprising an electrically conductive layer, located on a face of a substrate not comprising the solar control coating.

19. The laminated glazed unit according to claim 18, wherein the heating coating is on face 2 or face 3 or the laminated glazed unit.
